(19) United States
(12) Patent Application Publication
(10) Pub. No.: US 2014/0129311 A1
(43) Pub. Date: May 8, 2014

(54) SOCIAL MEDIA MARKETING

(71) Applicant: TRENDYR LLC, Niwot, CO (US)

(72) Inventors: Kiel James Patrick, Carnston, RI (US); Ron Snyder, Niwot, CO (US); Mike Margolis, Boulder, CO (US); Michael Alahverdian, Providence, RI (US); Steven Barbera, Wakefield, RI (US)

(73) Assignee: trendyr LLC, Niwot, CO (US)

(21) Appl. No.: 13/670,238

(22) Filed: Nov. 6, 2012

(51) Int. Cl. G06Q 30/02

(52) U.S. Cl. 705/14.23

(57) ABSTRACT

An incentive option is presented in an e-commerce shopping cart that includes transaction information corresponding to a transaction. A user selection of the incentive option is received and a social media action option is presented. An indication of an available incentive associated with the social media action option. Upon receiving a user selection of the social media action option, a social media incentive service facilitates the social media action and application of the available incentive.

### BACKGROUND

Recently, social media has become an important avenue for marketing. Conventional campaigns do not include social media marketing options within an e-commerce shopping cart.

### SUMMARY

Embodiments of the subject matter disclosed herein facilitate social media marketing by providing an incentive option in a shopping cart. In embodiments, a social media incentive service presents options corresponding to social media actions (e.g., “share,” “post,” “like,” “follow”) in response to receiving a user selection of the incentive option. By selecting a social media action option, the user may qualify for incentives such as, for example, discounts, loyalty program points, free shipping, registration for free gifts, or the like.

According to embodiments, an incentive option is presented in an e-commerce shopping cart that includes transaction information corresponding to a transaction. A user selection of the incentive option is received and a social media action option is presented. Embodiments also include presenting an indication of an available incentive associated with the social media action option. Upon receiving a user selection of the social media action option, a social media incentive service facilitates the social media action and application of the available incentive to the transaction.

While multiple embodiments are disclosed, still other embodiments of the disclosed subject matter will become apparent to those skilled in the art from the following detailed description, which shows and describes illustrative embodiments of the disclosed subject matter. Accordingly, the drawings and detailed description are to be regarded as illustrative in nature and not restrictive.

### BRIEF DESCRIPTION OF THE DRAWINGS

FIG. 1 is a block diagram illustrating an operating environment in accordance with embodiments of the disclosure;

FIG. 2 is a flow diagram depicting an illustrative method of facilitating social media marketing in accordance with embodiments of the disclosure;

FIG. 3 is a flow diagram depicting an illustrative method of facilitating social media marketing in accordance with embodiments of the disclosure;

FIG. 4 is a screen shot depicting a user interface in accordance with embodiments of the disclosure;

FIG. 5 is a screen shot depicting a user interface in accordance with embodiments of the disclosure; and

FIG. 6 is a screen shot depicting a user interface in accordance with embodiments of the disclosure.

While the subject matter disclosed herein is amenable to various modifications and alternative forms, specific embodiments have been shown by way of example in the drawings and are described in detail below. The disclosed subject matter, however, is not limited to the particular embodiments described. On the contrary, the disclosed subject matter is intended to cover all modifications, equivalents, and alternatives falling within the scope of the disclosure as defined by the appended claims.

### DETAILED DESCRIPTION

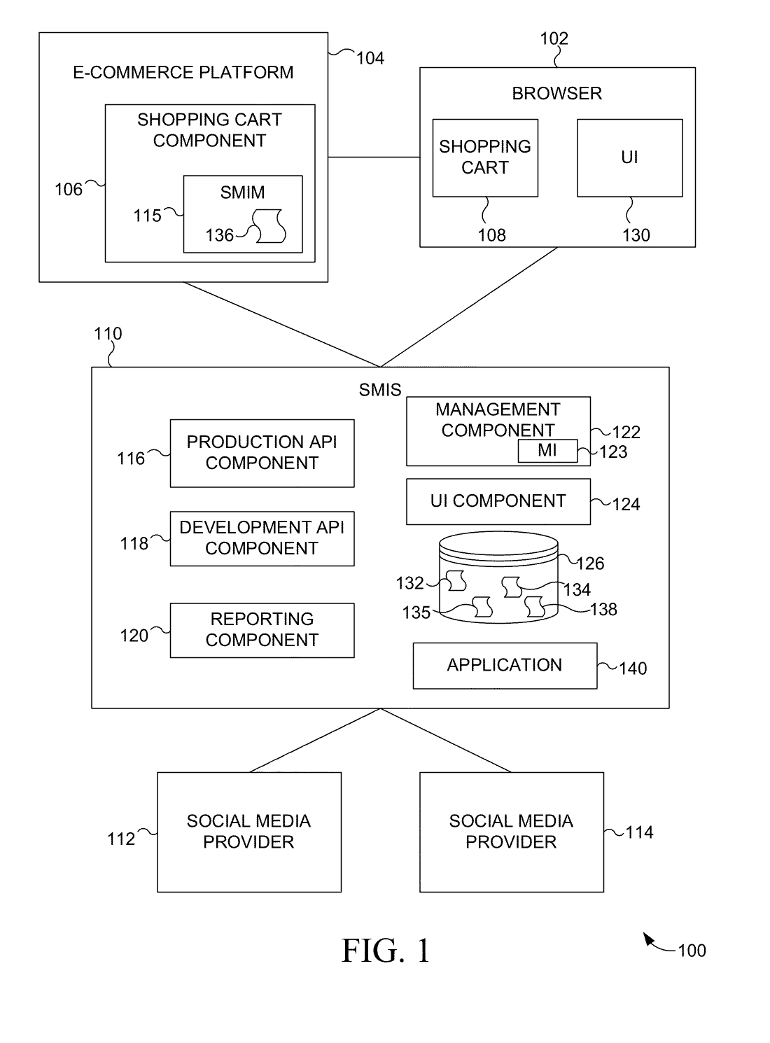

FIG. 1 depicts an illustrative operating environment 100 in accordance with embodiments of the disclosed subject matter. As illustrated in FIG. 1, a user (not shown) utilizes a browser 102 to interact with an e-commerce platform 104. In embodiments, the e-commerce platform 104 may include any number of servers (e.g., web servers) associated with a merchant (e.g., retailer, wholesaler, service-provider, organization, individual, or the like). In embodiments, the e-commerce platform 104 may include a number of servers associated with a number of entities. For example, in some embodiments, the e-commerce platform 104 may include a server hosted by a merchant that interacts with a server hosted by an e-commerce service provider. According to embodiments, the e-commerce platform 104 may provide one or more websites through which a user can purchase products and/or services. Exemplary e-commerce platforms include, but are not limited to, Demandware®, Magento®, Amazon®, Netsuite®, and Hybris®.

As shown in FIG. 1, the e-commerce platform 104 includes a shopping cart component 106 that facilitates presenting a shopping cart 108 on the browser 102. In embodiments, the shopping cart component 106 may be hosted by a merchant server, a service provider, and/or any other entity. In embodiments, the shopping cart 108 includes transaction information corresponding to a pending transaction. For example, in embodiments, a shopping cart 108 may include an indication of an item, the price of the item, the quantity of the item that has been requested by the user, and the like. Throughout this disclosure, the term “item” refers to the subject matter of an e-commerce transaction and may include, for example, a product, a service, a package of products and/or services, a warranty, a property interest, or the like.

As is illustrated in FIG. 1, the operating environment 100 includes a social media incentive service (SMIS) 110. According to embodiments, the SMIS 110 facilitates social media marketing via social media providers 112, 114 by providing transaction incentive services associated with the e-commerce platform 104. Social media providers 112 and 114 may include entities and the servers, websites, networks, or the like, hosted by the entities. In embodiments, the SMIS 110 provides a social media incentive module (SMIM) (e.g., a plug-in) 115 to the e-commerce platform 104. In embodiments, the SMIM 115 may include software that facilitates interactions with the SMIM 110 and may include, for example, a JavaScript module or library, a component that provides browser extensions, a client application, a server application, an application programming interface (API), an applet, or the like. As shown in FIG. 1, the SMIM 115 may be installed or integrated within the shopping cart component 106. In other embodiments, the SMIM 115 may be installed on the e-commerce platform independent of the shopping cart component 106.

As shown in FIG. 1, embodiments of the SMIS 110 may include a production API component 116, a development API component 118, a reporting component 120, a management component 122, a user interface (UI) component 124, and a memory component 126. According to embodiments, the production API component 116 facilitates providing social media incentives and may include, or provide, any number of APIs that may communicate with the SMIM 115, other components of the SMIS 110, social media providers 112 and 114, or the like. In embodiments, the development API component 118 may include, or provide, any number of APIs similar to those of the production API component 116 and may be used by the e-commerce platform 104 to develop, test, and trouble-shoot social media incentive processes and interactions.

In embodiments, the reporting component 120 monitors interactions among the browser 102, the e-commerce platform 104, the SMIS 110, and the social media providers 112 and 114. The reporting component 120 may be used to collect information corresponding to any number of different user behaviors, demographics, social media interactions, transactions, and the like. In embodiments, the management component 122 interacts with the e-commerce platform 104 to provide a management interface (MI) 123 through which a merchant can configure social media incentive campaigns, functionality, and the like. Additionally, in embodiments, the management component 122 may provide information obtained (and, in embodiments, processed) by the reporting component 120 to the merchant (e.g., via the MI 123). In embodiments, the management component 122 may communicate through a web page, the e-commerce platform 104, or the like.

In embodiments, the UI component 124 facilitates presenting a UI 130 on the browser 102. In embodiments, the UI 130 presents selectable options corresponding to social media actions, which may include, for example, options for authenticating with a social media provider 112 or 114 (referred to herein as “authentication options”), options for performing social media actions (referred to herein as “social media action options”), and the like. In embodiments, the UI component 124 may communicate with the browser 102 via the e-commerce platform 104, via a separate communication connection, or the like.

In embodiments, the memory component 126 includes computer-readable media. Computer-readable media may include both volatile and non-volatile media, removable and nonremovable media, and contemplate media readable by a database, a processor, a router, and various other networked devices. By way of example, and not limitation, computer-readable media may include media implemented in any method or technology for storing information. Media examples include, but are not limited to, Random Access Memory (RAM); Read Only Memory (ROM); Electronically Erasable Programmable Read Only Memory (EEPROM); flash memory or other memory technologies; Compact Disc Read-Only Memory (CD-ROM), digital versatile disks (DVDs) or other optical or holographic media; magnetic cassettes, magnetic tape, magnetic disk storage or other magnetic storage devices; data transmissions; or any other medium that can be used to encode information and can be accessed by a computing device such as, for example, quantum state memory, and the like.

In embodiments, the memory component 126 stores computer-executable instructions 132 for causing one or more processors to perform aspects of embodiments of methods discussed herein. Computer-executable instructions can include, for example, computer code, machine-useable instructions, and the like such as, for example, program components, capable of being executed by one or more processors associated with a computing device. Generally, program components including routines, programs, objects, modules, data structures, and the like, refer to code that, when executed, causes a computing device to perform particular tasks (e.g., methods, calculations, etc.) or implement or manipulate various abstract data types. For example, in embodiments, the memory component 126 includes a database 134 that may be used to save configuration data, user data, and the like. Additionally, in embodiments, the memory component 126 includes various program components such as, for example, components 116, 118, 120, 122, and 124. Some or all of the functionality contemplated herein may also be implemented in hardware and/or firmware.

In embodiments, the memory component 126 may include a library 135 that includes information specific to various shopping cart software (and/or types of shopping cart software) to facilitate integration with different shopping carts 108 (and/or types of shopping carts 108) and/or e-commerce platforms 104. In embodiments, the SMIM 115 may include a library 136 that may be used by the SMIM 115 to integrate with the particular shopping cart component 106. For example, in embodiments, the library 136 may include various translation files, communication protocols, data mappings, methods, APIs, definitions, and the like.

According to embodiments, in operation, a user navigates to a merchant's website using the browser 102. The merchant's website may include, or interface with, the e-commerce platform 104. The user adds one or more items to the shopping cart 108 and navigates to the shopping cart 108 using the browser 102. The shopping cart 108 includes transaction information corresponding to the pending transaction. The e-commerce platform 104 determines whether a transaction key is associated with the transaction. In embodiments, for example, the transaction key is an identifier used by the SMIS 110 to identify the transaction and associate processes and information with the transaction. According to embodiments, the SMIS 110 creates a representation 138 of the transaction. The SMIS 110 may maintain the representation 138 in the memory component 126 until the transaction is completed. The representation 138 may include transaction information, discount information, user information, and any other type of information that may be used by the SMIS 110 to facilitate providing social media marketing services, providing incentive services, providing information and behavior tracking services, and the like.

If a transaction key is not associated with the transaction, the e-commerce platform 104 may request a transaction key from the SMIS 110. In embodiments, this request is made by the SMIM 115, which may make a call, for example, to the production API component 116. In embodiments, the request includes at least a portion of the transaction information, which may be used by the SMIS 110 to create a representation of the transaction. The production API component 116 may reply to the request by providing a transaction key to the e-commerce platform 104 (e.g., via the SMIM 115). If a transaction key is associated with the transaction, the e-commerce platform 104 may determine whether the transaction has been updated (e.g., items added to, or removed from, the transaction). If the transaction has been updated, the e-commerce platform 104 may provide (e.g., via the SMIM 115) updated transaction information to the SMIS 110 (e.g., via the production API component 116), which may update the representation 138 with the updated transaction information.

In embodiments, the e-commerce platform 104 may instantiate the SMIM 115. The SMIM 115 may be, include, or interact with, the library 136 (e.g., a Javascript library). In embodiments, the SMIM 115 may be dynamically loaded from the memory component 126 of the SMIS 110 and may communicate with the production API component 116 to facilitate embodiments of the functionality described herein. In embodiments, a portion of the SMIM 115 may reside on the e-commerce platform 104 and a portion of the SMIM 115 may reside on the SMIS 110. For example, in embodiments, the SMIM 115 may be a client application that interacts with a server application (e.g., the production API component 116) in a client-server communication architecture.

In embodiments, instantiation of the SMIM 115 causes an incentive option to be presented in the shopping cart 108. In other embodiments, the e-commerce platform 104 may interact with the SMIM 115 or some other component to cause the incentive option to be presented. The incentive option may be a button, icon, or the like and may interface directly, or indirectly, with the SMIS 110. In embodiments, the incentive option may include, or have associated therewith, information indicating that selection of the incentive option can facilitate obtaining one or more incentive in exchange for sharing information about the transaction via one or more social media providers 112 and 114 (e.g., by performing one or more social media actions).

In embodiments, when the user selects the incentive option, the SMIS 110 presents options corresponding to social media actions that can be performed by, or on behalf of, the user. For example, in embodiments, social media actions may include posting on a Facebook® wall, “liking” an item or merchant via Facebook®, “tweeting” about an item or merchant via Twitter®, “following” a merchant via Twitter®, and the like. According to embodiments, the SMIS 110 may present any number of options corresponding to social media actions. Options corresponding to social media actions may include, for example, authentication options, social media action options, and the like. In embodiments, the SMIS 110 presents these selectable options on a UI 130 via the browser 102. In embodiments, the UI 130 may be presented as modal window, an overlay, a separate window, an embedded window, or the like.

Upon receiving a user selection of an authentication option, the SMIS 110 may facilitate connecting the user with the social media provider 112, 114 and, upon receiving a user selection of a social media action option, the SMIS 110 may facilitate the social media action. For example, in an embodiment, the SMIS 110 presents a button that is hyperlinked to an authentication interface (e.g., log-in screen) associated with a social media provider 112 or 114. Once the user has authenticated with the social media provider 112 or 114, the social media action may be performed. In embodiments, the SMIS 110 may cause the social media action to be performed upon authentication of the user. In embodiments, the SMIS 110 may present social media action options corresponding to specific social media actions when the user has authenticated with the social media provider 112 or 114. Additionally, in embodiments, the SMIS 110, merchant, or other entity may host, or interact with, an application 140 that interfaces with, or is hosted by, the social media provider 112 or 114. The application 140 may facilitate social media actions.

In embodiments, when the user has selected one or more social media action options (and, thus, the corresponding social media actions have been performed), the e-commerce platform 104 determines whether any incentives should be applied to the transaction by determining whether the user qualifies for any incentives. In embodiments, the e-commerce platform 104 queries the SMIS 110 to determine whether the user qualifies for any incentives (e.g., by virtue of having selected/performed one or more social media actions). For example, the e-commerce platform 104 may request incentive qualification information from the SMIS 110. The SMIS 110 may provide a response to the e-commerce platform 104 that includes qualification information indicating whether the user qualifies for any incentives and, if so, which incentives the user is qualified for. If the user is qualified for an incentive, the e-commerce platform 104 applies the incentive (e.g., to the transaction, to a user account, to an associated transaction, or the like) and may process the transaction via the shopping cart. If the user is not qualified for an incentive, the e-commerce platform 104 may simply process the transaction via the shopping cart.

According to embodiments, various components of the operating environment 100, illustrated in FIG. 1, can be implemented on one or more computing devices. According to embodiments, a computing device can include any type of computing device suitable for implementing embodiments of the invention. Examples of computing devices include “workstations,” “servers,” “laptops,” “desktops,” “tablet computers,” “hand-held devices,” and the like, all of which are contemplated within the scope of FIG. 1 and reference to various components of the operating environment 100. In embodiments, components of the operating environment 100 can include more than one computing device such as, for example, in a distributing computing environment, a networked environment, and the like.

In embodiments, a computing device includes a bus that, directly and/or indirectly, couples the following devices: a processor, a memory, an input/output (I/O) port, an I/O component, and a power supply. Any number of additional components, different components, and/or combinations of components can also be included in the computing device. The bus represents what may be one or more busses (such as, for example, an address bus, data bus, or combination thereof). Similarly, in embodiments, the computing device can include a number of processors, a number of memory components, a number of I/O ports, a number of I/O components, and/or a number of power supplies. Additionally any number of these components or combinations thereof can be distributed and/or duplicated across a number of computing devices.

The illustrative operating environment 100 shown in FIG. 1 is not intended to suggest any limitation as to the scope of use or functionality of embodiments of the subject matter disclosed throughout this document. Neither should the illustrative operating environment 100 be interpreted as having any dependency or requirement related to any single component or combination of components illustrated therein. For example, in embodiments, the illustrative operating environment 100 can include additional components. Additionally, any one or more of the components depicted in FIG. 1 can be, in embodiments, integrated with various ones of the other components depicted therein (and/or components not illustrated). Any number of other components and/or combinations of components can be integrated with the illustrative operating environment 100 depicted in FIG. 1, all of which are considered to be within the ambit of the disclosure.

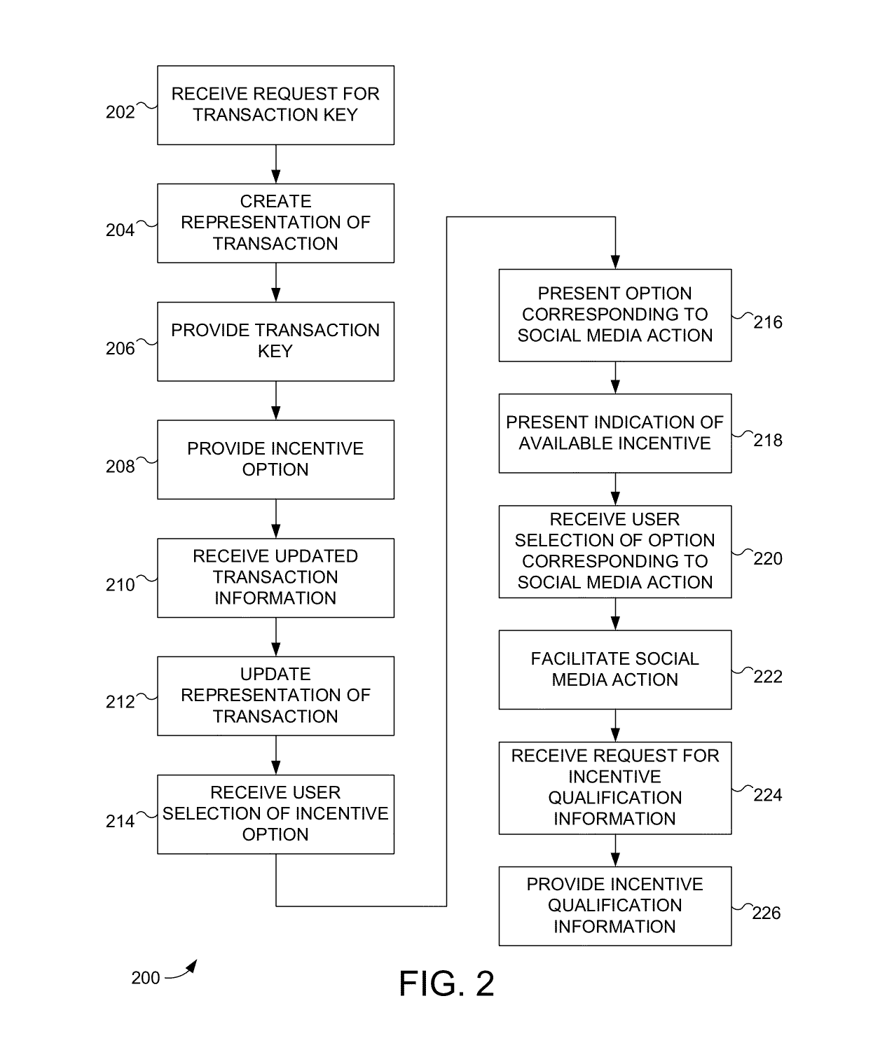

FIG. 2 is a flow diagram depicting an illustrative method 200 performed by a social media incentive service (e.g., SMIS 110 shown in FIG. 1) for facilitating social media marketing in accordance with embodiments of the disclosed subject matter. As shown in FIG. 2, the SMIS receives a request for a transaction key from an e-commerce platform (e.g., e-commerce platform 104 shown in FIG. 1) (block 202). In embodiments, the request may include transaction information corresponding to a transaction, information about a user that is proposing the transaction, information about the e-commerce platform, and the like. In embodiments, the e-commerce platform may separately provide transaction information to the SMIS. The SMIS creates a representation of the transaction (block 204) and provides a transaction key to the e-commerce platform (block 206).

Embodiments of the method 200 further include providing an incentive option for presentation in an e-commerce shopping cart (e.g., shopping cart 108 shown in FIG. 1) (block 208). In embodiments, the shopping cart is displayed on a browser and may include transaction information corresponding to the transaction. As the user adds items to the shopping cart, the e-commerce platform may determine that the shopping cart has been updated and provide updated transaction information to the SMIS. Accordingly, embodiments of the method 200 include receiving updated transaction information from the e-commerce platform (block 210) and updating the representation of the transaction with the updated transaction information (block 212).

In embodiments, a user selection of the selectable incentive option is received (block 214) and, in response to receiving the user selection, the SMIS presents an option corresponding to a social media action (block 216). In embodiments, for example, the SMIS presents the option on a user interface (UI) (e.g., UI 130 depicted in FIG. 1). The SMIS also may present an indication of an available incentive corresponding to the social media action (block 218). According to embodiments, the option corresponding to the social media action may include, for example, an authentication option, if the user is not already authenticated with the corresponding social media provider; a social media action option, if the user is authenticated with the social media provider; or the like.

Embodiments of the method 200 further include receiving a user selection of the option corresponding to the social media action (block 220) and facilitating the social media action (block 222). According to embodiments, the SMIS may facilitate the social media action by enabling the user to perform the social media action, performing the social media action on behalf of the user, or the like. In embodiments, the SMIS may present options corresponding to any number of social media actions associated with any number of social media providers. According to embodiments, the SMIS may facilitate application of available incentives to the pending transaction by informing the e-commerce platform that the user has qualified for certain incentives, based on social media actions. For example, as shown in FIG. 2, the SMIS may receive, from the e-commerce platform, a request for incentive qualification information (block 224) and may, in response to the request, provide incentive qualification information to the e-commerce platform (block 226).

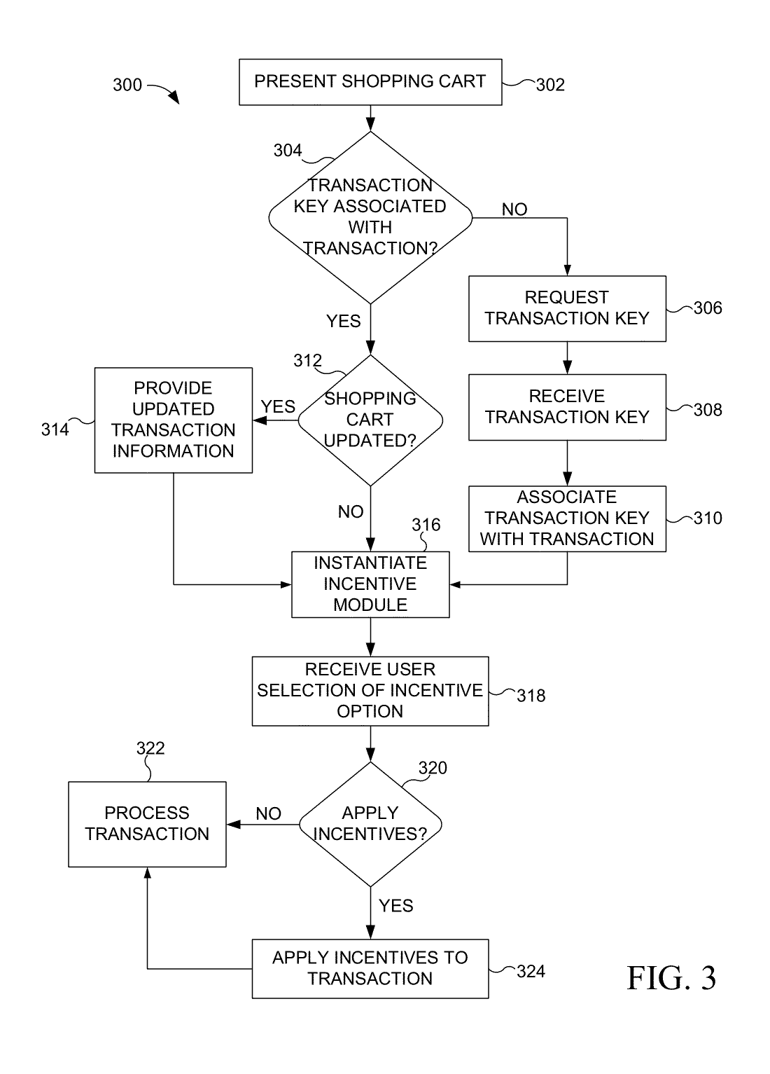

FIG. 3 is a flow diagram depicting an illustrative method 300 that may be performed, for example, by an e-commerce platform (e.g., e-commerce platform 104 shown in FIG. 1) for facilitating social media marketing in accordance with embodiments of the disclosed subject matter. In embodiments, the e-commerce platform presents an e-commerce shopping cart (e.g., shopping cart 108 shown in FIG. 1) on a browser (e.g., browser 102 shown in FIG. 1) (block 302). The shopping cart includes transaction information corresponding to a pending transaction. The e-commerce platform determines whether a transaction key (e.g., provided by an SMIS such as SMIS 110 shown in FIG. 1) is associated with the transaction (block 304). If a transaction key is not associated with the transaction, the e-commerce platform requests a transaction key from the SMIS (block 306). In embodiments, the e-commerce platform provides at least a portion of the transaction information to the SMIS to facilitate creation of a representation of the transaction. As shown in FIG. 3, the e-commerce platform receives a transaction key from the SMIS (block 308) and associates the transaction key with the transaction (block 310).

If, at decision block 304, the e-commerce platform determines that a transaction key is associated with the transaction, the e-commerce platform determines whether the shopping cart has been updated (block 312). If the shopping cart has been updated, the e-commerce platform provides updated transaction information to the SMIS (block 314). As shown in FIG. 3, the e-commerce platform instantiates an incentive module (block 316), which may facilitate presentation of an incentive option. In embodiments, the e-commerce platform receives a user selection of the incentive option (block 318). In other embodiments, the SMIS may receive the user selection of the incentive option, either directly or indirectly, through the e-commerce platform.

In embodiments, the e-commerce platform determines whether to apply an incentive, or incentives, to the transaction (block 320). In embodiments, the e-commerce platform may determine whether to apply the incentive, or incentives, to a related transaction, a shipping cost, a user account, a contest, or the like. For example, in embodiments, the e-commerce platform determines whether to apply incentives by querying the SMIS. If the e-commerce platform determines that incentives are not to be applied, the transaction may be processed (block 322). If the e-commerce platform determines that incentives are to be applied, the incentives are applied to the transaction (block 324) and the transaction (e.g., with discounts or other incentives) is processed (block 322).

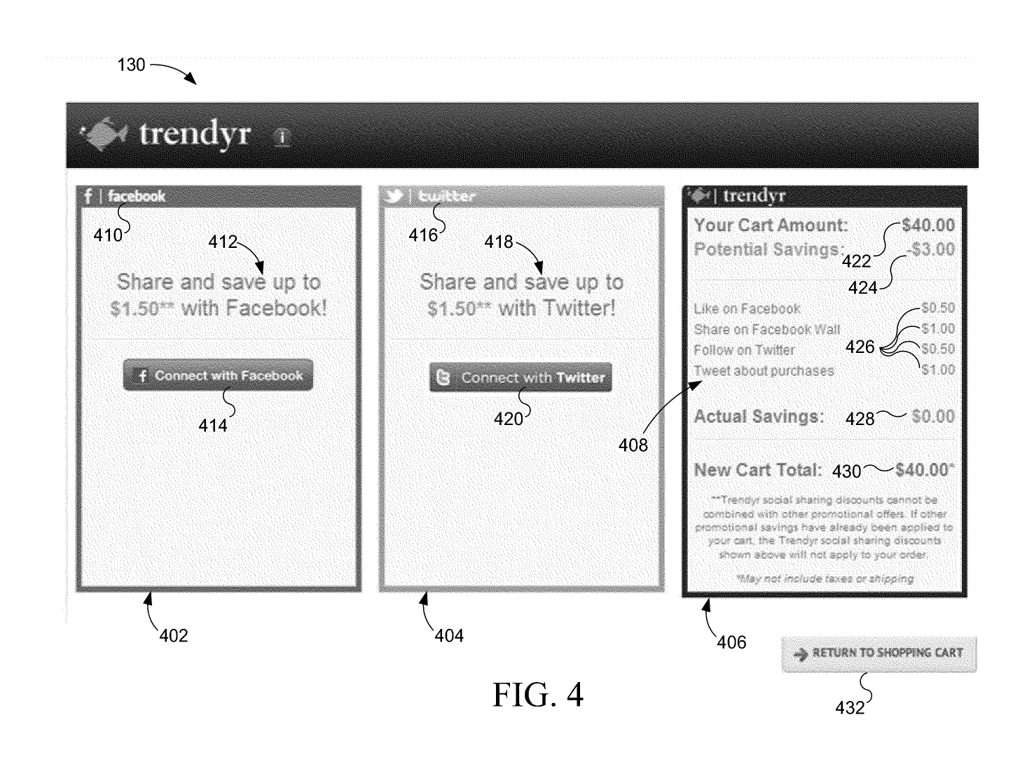

FIGS. 4-6 are screenshots that depict an illustrative example of a user interface (UI) 130 (e.g., UI 130 shown in FIG. 1), in accordance with embodiments. As shown in FIGS. 4-6, the UI 130 may include one or more regions 402, 404, and 406. In embodiment, each region 402, 404, and 406 may include, for example, a frame, a window, a portion of a frame or window, or the like. For example, in embodiments, a first region 402 corresponds to a first social media provider (e.g., social media provider 112 shown in FIG. 1), a second region 404 corresponds to a second social media provider (e.g., social media provider 114 shown in FIG. 1), and a third region 406 includes transaction summary information 408. The UI 130 depicted in FIGS. 4-6 is intended to be a non-limiting example and, according to embodiments, the UI 130 may include any number of regions, configurations, appearances, features, and the like. Moreover, while the first social media provider is depicted as Facebook® and the second social media provider is depicted as Twitter®, these are only examples of social media providers and, in embodiments, the regions of the UI 130 may correspond to any other social media providers.

As shown, the first region 402 includes an identification 410 of the first social media provider, an indication 412 of a first available aggregate incentive (which is, in the illustrated example, a discount), and a first selectable authentication option 414. Similarly, the second region 404 includes an identification 416 of the second social media provider, an indication 418 of a second available aggregate incentive, and a second authentication option 420. In embodiments, for example, the indication 412 of the first available aggregate incentive may include information (e.g., text) that indicates a total dollar amount available in discounts or other incentives associated with a set of social media actions corresponding to the first social media provider. The indication 418 of the second available aggregate incentive may provide similar information in reference to the second social media provider. According to embodiments, the set of social media actions may include one social media action, two social media actions, or any other number of social media actions. In embodiments, each social media action may have a corresponding available incentive and, in embodiments, a combination of social media actions may have a corresponding available incentive. The authentication options 414 and 420 may include, for example, hyperlinks to authentication interfaces (not shown) of the respective social media providers.

As shown in FIGS. 4-6, the transaction summary information 408 includes an indication 422 of the total purchase price of the item (or items), an indication 424 of a total available incentive (e.g., the sum of the first and second available aggregate incentives), indications 426 of the available incentives associated with each social media action, an indication 428 of the total incentive for which the user has qualified, and an indication 430 of the discounted purchase price. Additionally, as shown in FIGS. 4-6, the UI 130 may include a selectable option 432 for closing the UI 130 and returning to the shopping cart.

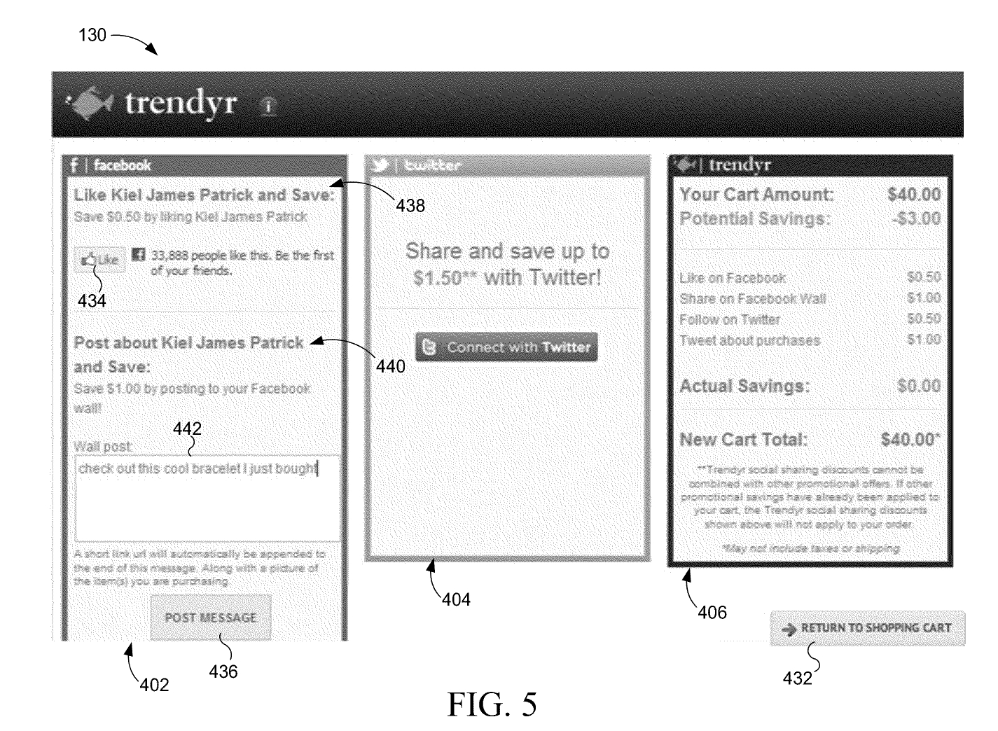

As depicted in FIG. 5, a user has selected the authentication option 414 and has authenticated with the first social media provider. Upon authentication, the first region 402 presents a first social media action option 434 (e.g., “Like”) and a second social media action option 436 (e.g., “post” to the user's wall). The first region 402 includes an indication 438 of an available incentive associated with the first social media action option 434 and an indication 440 of an available incentive associated with the second social media action option 436. As shown, the first region 402 also includes a text field 442 associated with the second social media action option 436, which may be used, for example, to receive text from the user.

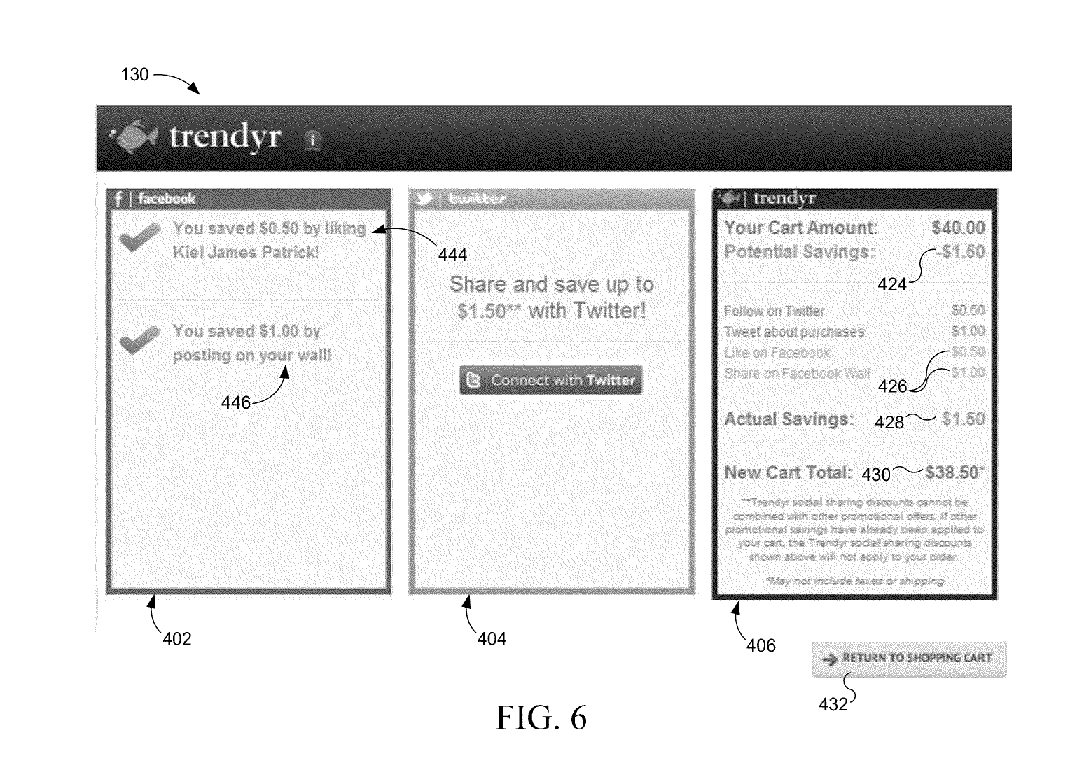

As shown in FIG. 6, in response to a user selection, for example, of the first and second social media action options 434 and 436, the first region 402 may include an incentive qualification indication 444 associated with the first social media action option 434 and associated available incentive and an incentive qualification indication 446 associated with the second social media action option 436 and associated available incentive, as depicted in FIG. 6. Each incentive qualification indication 444 and 446 indicates that the user has qualified for an incentive by selecting a social media action option 434 and 436, respectively. As shown in FIG. 6, the indication 424 of the total available incentive has been reduced by the amount for which the user has qualified, the indication 428 of the total incentive for which the user has qualified has been increased by that amount, and the indication 430 of the discounted purchase price has been reduced by that amount. In embodiments, the indications 426 of the available incentives associated with the incentive or incentives for which the user has qualified may be modified (or, in embodiments, replaced by another indication) to indicate that the user has qualified for the incentive or incentives.

While the subject matter of embodiments of the subject matter disclosed herein is described with specificity, the description itself is not intended to limit the scope of this patent. Rather, the inventors have contemplated that the claimed subject matter might also be embodied in other ways, to include different steps or features, or combinations of steps or features similar to the ones described in this document, in conjunction with other technologies. Moreover, although the term “block” may be used herein to connote different elements of methods employed, the term should not be interpreted as implying any particular order among or between various steps herein disclosed unless and except when the order of individual steps is explicitly called for.

The following is claimed:

1. A method for providing an incentive in a transaction that is facilitated using an e-commerce shopping cart provided by an e-commerce platform, wherein the e-commerce shopping cart is displayed on a browser, the method comprising:
providing an incentive option for presentation in an e-commerce shopping cart, the e-commerce shopping cart displaying transaction information corresponding to a transaction;
receiving a user selection of the incentive option;
presenting, in response to receiving the user selection, at least one social media action option, wherein the at least one social media action option corresponds to at least one social media action;
presenting an indication of an available incentive associated with the social media action option;
receiving a user selection of the at least one social media action option;
facilitating the at least one social media action; and
facilitating application of the available incentive.

2. The method of claim 1, wherein the at least one social media action comprises at least one of a social media action associated with a first social media provider and a social media action associated with a second social media provider.

3. The method of claim 1, wherein facilitating the social media action comprises performing the social media action on behalf of the user.

4. The method of claim 1, wherein presenting the at least one social media action option comprises presenting a user interface on the browser, wherein the user interface includes the at least one social media action option.

5. The method of claim 4, the user interface comprising a first region including the at least one social media action option and a second region including transaction summary information, the transaction summary information including an indication of a total available incentive.

6. The method of claim 5, further comprising updating the transaction summary information in response to receiving a user selection of the social media action option.

7. The method of claim 1, further comprising presenting an authentication option associated with at least one social media provider.

8. The system of claim 1, further comprising storing, in a memory component, tracking information associated with at least one of the transaction and the at least one social media action.

9. The method of claim 1, further comprising:
receiving a request, from the e-commerce platform, for a transaction key, wherein the request includes at least a portion of the transaction information;
creating a representation of the transaction, wherein the representation includes the transaction key; and
providing the transaction key to the e-commerce platform.

10. The method of claim 9, further comprising receiving updated transaction information from the e-commerce platform and updating the representation with the updated transaction information.

11. The method of claim 1, further comprising:
receiving, from the e-commerce platform, a request for incentive qualification information; and
providing incentive qualification information to the e-commerce platform.

12. A method for providing an incentive in a transaction that is facilitated using an e-commerce shopping cart, wherein the e-commerce shopping cart is displayed on a browser, the method comprising:
presenting an e-commerce shopping cart, the shopping cart including transaction information corresponding to a transaction;
providing at least a portion of the transaction information to a social media incentive service;
receiving a transaction key from the social media incentive service, wherein the transaction key comprises a unique identifier corresponding to the transaction;
associating the transaction key with the transaction;
instantiating an incentive module, wherein the incentive module presents an incentive option;
receiving a user selection of the incentive option, wherein the social media incentive service presents, in response to receiving the user selection, at least one social media action option corresponding to at least one social media action, and wherein the social media incentive service further presents an indication of an available incentive associated with the at least one social media action option;
determining that the user has qualified for the available incentive; and
applying the available incentive.

13. The method of claim 12, wherein the at least one social media action comprises at least one of a social media action associated with a first social media provider and a social media action associated with a second social media provider.

14. The method of claim 12, further comprising receiving, from the social media incentive service, tracking information associated with at least one of the transaction and the at least one social media action.

15. The method of claim 12, further comprising determining that the e-commerce shopping cart has been updated and providing updated transaction information to the social media incentive service.

16. The method of claim 12, wherein determining that the user has qualified for the available incentive comprises:
requesting incentive qualification information from the social media incentive service; and
receiving incentive qualification information from the social media incentive service.

17. One or more computer-readable media having computer-executable instructions embodied thereon for facilitating social media marketing associated with a transaction that is facilitated using an e-commerce shopping cart hosted by an e-commerce platform, the media comprising a plurality of program components, the components comprising:
an application programming interface (API) component that includes at least one API; and
a social media incentive module that communicates with the at least one API, wherein the social media incentive module facilitates presentation of an incentive option on a browser, and wherein the API component receives transaction information from the social media incentive module and creates a representation of the transaction that includes at least a portion of the transaction information.

18. The media of claim 17, wherein the social media incentive module further comprises a library that facilitates integration of the social media incentive module with a shopping cart component of the e-commerce platform.

19. The media of claim 17, further comprising a user interface component that presents a user interface on the browser, wherein the user interface includes at least one option corresponding to at least one social media action.

20. The media of claim 17, further comprising a reporting component that obtains tracking information associated with at least one of the transaction and the at least one social media action and a management component that provides a management interface, wherein the management interface displays at least a portion of the tracking information.
